(19) United States
(12) Patent Application Publication
(10) Pub. No.: US 2024/0327577 A1
(43) Pub. Date: Oct. 3, 2024

(54) LOW DENSITY CAST SILICONE FOAM AND PREPARATION THEREOF

(71) Applicant: ROGERS CORPORATION, Chandler, AZ (US)

(72) Inventors: Kshitish A. Patankar, Naperville, IL (US); Katherine Vuong, Chicago, IL (US); Kenneth Mazich, Chicago, IL (US)

(21) Appl. No.: 18/618,461

(22) Filed: Mar. 27, 2024

Related U.S. Application Data
(60) Provisional application No. 63/462,607, filed on Apr. 28, 2023.
(60) Provisional application No. 63/455,802, filed on Mar. 30, 2023.

(51) Int. Cl. C08G 77/20; C08G 77/08; C08G 77/12; C08G 77/16; C08J 9/00; C08J 9/06; C08J 9/12; C08J 9/14; C08K 3/12

(52) U.S. Cl. CPC C08G 77/20; C08G 77/08; C08G 77/12; C08G 77/16; C08J 9/0066; C08J 9/06; C08J 9/125; C08J 9/127; C08J 9/142; C08K 3/12; C08G 2110/0041; C08J 2201/022; C08J 2203/10; C08J 2203/12; C08J 2203/204; C08J 2205/052; C08J 2383/05; C08J 2383/06; C08J 2383/07

(57) ABSTRACT

A curable composition for preparing a low density cast silicone foam includes a first part and a second part. The first part includes particular amounts of an alkenyl-terminated polyorganosiloxane; an alkenyl-substituted copolyorganosiloxane; an alkenyl-substituted MQ polyorganosiloxane; a cure catalyst; an inorganic filler; and a chemical blowing agent. The second part includes a hydride-substituted polyorganosiloxane. The resulting silicone foams advantageously have a density of less than 240 kg/m³; and a closed cell content of at least 50%. Cured silicone foams and methods for the manufacture thereof are also described.

### CROSS-REFERENCE TO RELATED APPLICATIONS

This application claims priority to U.S. Provisional Patent Application No. 63/462,607, filed on Apr. 28, 2023, and U.S. Provisional Patent Application No. 63/455,802, filed on Mar. 30, 2023, the contents of both of which are hereby incorporated by reference in their entirety.

### BACKGROUND

Soft silicone foams are widely used for sealing and vibration damping in applications as diverse as transportation and electronic devices. However, technical performance requirements have increased at the same time that size and weight performance requirements have decreased. Thus, there remains a continuing need for thin silicone foams with excellent physical properties.

Development of lower density, cast silicone foams is of interest due to expected improved compression and weight profiles. However, thin cast foams tend to suffer from high density due to the compression of the foaming sheet and rupture of the bubbles therein during manufacturing.

There is accordingly a need for compositions and methods to form low density cast silicone foams that meet physical properties as currently desired. It would be a further advantage to avoid the use of fluorinated surfactants, which can affect the uniformity of the foamed product, providing less than optimal properties.

### SUMMARY

A curable composition for preparing a low density cast silicone foam comprises: a first part comprising, based on the total weight of the first part: 40 to 70 weight percent of an alkenyl-terminated polyorganosiloxane; 0.1 to 10 weight percent of an alkenyl-substituted copolyorganosiloxane; 5 to 30 weight percent of an alkenyl-substituted MQ polyorganosiloxane; a cure catalyst; an inorganic filler; and 0.1 to 1.5 weight percent of a chemical blowing agent comprising water, a silanol-terminated polyorganosiloxane; and optionally, an alcohol; and a second part comprising a hydride-substituted polyorganosiloxane; wherein the low density cast silicone foam has a density of less than 240 kg/m³; and wherein the low density cast silicone foam has a closed cell content of at least 50%.

A cured silicone foam layer comprising a cured product of the curable composition represents another aspect of the present disclosure.

A method for forming a silicone foam sheet comprises casting the curable composition onto a first release layer; placing a second release layer on a side of the cast curable composition opposite the first release liner to form a multilayer structure; and passing the cast curable composition on the substrate through the nip of two rotating rollers to meter the amount of curable composition; and curing the curable composition to form the silicone foam sheet.

A silicone foam sheet formed according to the method represents another aspect of the present disclosure.

The above described and other features are exemplified by the following detailed description.

### DETAILED DESCRIPTION

The present inventors have surprisingly discovered curable compositions for producing low density cast silicone foams with desirable properties, in particular density, compressive force deflection, and cell morphology. In an unexpected and advantageous feature, the curable compositions described herein can be used in a casting process to provide the low density foam without suffering from the technical limitations described above. In a further advantageous feature, the low density cast silicone foams can be produced without the use of a fluorinated surfactant. Fluorinated surfactants and other compounds have been relied upon for many years in the art to stabilize silicone foams during casting and curing. “Fluorinated surfactants” as used herein accordingly includes nonionic fluorinated polymers known in the art to stabilize silicone foams, for example fluorinated polyethers and fluorinated polyorganosiloxanes. Special types of fluorinated surfactants have been used, for example the profoamers described in U.S. Pat. No. 4,608,396 to Bauman et al., and the references cited therein. Fluorinated surfactants have come under scrutiny, however, due to their environmental health and safety profile. So, moving away from fluorinated surfactant is desirable, however previous use of these surfactants has been necessary to obtain the desired cell structure. Thus, it was unexpected that low density cast silicone foams with excellent properties can be produced even in the absence of a fluorinated surfactant using the curable compositions described herein. A significant advantage is therefore provided by the present disclosure.

Accordingly, an aspect of the present disclosure is a curable composition for preparing a low density cast silicone foam. To obtain the advantageous properties of the low density cast silicone foam, a specific combination of materials for the curable composition is used, as described in greater detail herein. The relative amounts of each component in the curable composition can be adjusted to provide desirable properties in the cured silicone foam.

The curable composition comprises a first part and a second part. The first part and the second part can be mixed to provide the curable composition.

The first part comprises an alkenyl-terminated polyorganosiloxane. Suitable polyorganosiloxanes terminated with an alkenyl group are generally represented by the formula:

MₐD_{b}T_{c}Q_{d},

wherein the subscripts a, b, c, and d are zero or a positive integer, subject to the limitation that if subscripts a and b are both equal to zero, subscript c is greater than or equal to two; M has the formula R₃SiO_{1/2}; D has the formula R₂SiO_{2/2}; T has the formula RSiO_{3/2}; and Q has the formula SiO_{4/2}, wherein each R group independently represents hydrogen, terminally-substituted C₁₋₆ alkenyl groups, substituted and unsubstituted monovalent hydrocarbon groups having from one to forty, or 1 to 6 carbon atoms each, subject to the limitation that at least 1, for example, at least 2, of the R groups are alkenyl R groups. Suitable alkenyl R-groups are exemplified by vinyl, allyl, 1-butenyl, 1-pentenyl, and 1-hexenyl, with vinyl being particularly useful. The alkenyl group is bonded at the molecular chain terminals, i.e., an alkenyl-terminated polyorganosiloxane. Preferably, the alkenyl-terminated polyorganosiloxane is an alkenyl-diterminated polyorganosiloxane, wherein two of the chain ends are alkenyl groups. As used herein, a vinyl group is a group having the formula —CH═CH₂, and a “substituted vinyl group” has the formula —CH═CR₂, where the R groups can be independently hydrogen or C₁₋₆ alkyl groups. The vinyl concentration in the alkenyl-terminated polyorganosiloxane can be, for example 0.001 to 1 weight percent, or 0.01 to 0.5 weight percent, or 0.01 to 0.15 weight percent, or 0.01 to 0.1 weight percent.

In an aspect, the alkenyl-terminated polyorganosiloxane can have a viscosity of greater than 500 centipoise (cP), for example greater than 1,000 cP, or greater than 5,000 cP, or greater than 10,000 cP. In a specific aspect, the alkenyl-terminated polyorganosiloxane can have a viscosity of 50,000 to 70,000 cP.

Other silicon-bonded organic groups in the alkenyl-terminated polyorganosiloxane, when present, are exemplified by substituted and unsubstituted monovalent hydrocarbon groups having from one to forty carbon atoms, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Methyl and phenyl are specifically useful.

The alkenyl-terminated polyorganosiloxane can have straight chain, partially branched straight chain, branched-chain, or network molecular structure, or can be a mixture of such structures. The alkenyl-terminated polyorganosiloxane is exemplified by vinyl-endblocked polydimethylsiloxanes; vinyl-endblocked dimethylsiloxane-diphenylsiloxane copolymers; vinyl-endblocked dimethylsiloxane-methylphenylsiloxane copolymers; vinyl-endblocked dimethylsiloxane-methylphenylsiloxane-diphenylsiloxane copolymers; vinyl-endblocked dimethylsiloxane-methylphenylsiloxane copolymers; vinyl dimethylsiloxane-methylvinylsiloxane copolymers; vinyl-endblocked methylvinylsiloxane-methylphenylsiloxane copolymers; vinyl-endblocked dimethylsiloxane-methylvinylsiloxane-methylphenylsiloxane copolymers; dimethylvinylsiloxy-endblocked methylvinylpolysiloxanes; dimethylvinylsiloxy-endblocked methylvinylphenylsiloxanes; dimethylvinylsiloxy-endblocked dimethylvinylsiloxane-methylvinylsiloxane copolymers; dimethylvinylsiloxy-endblocked dimethylsiloxane-methylphenylsiloxane copolymers; dimethylvinylsiloxy-endblocked dimethylsiloxane-diphenylsiloxane copolymers; or a combination thereof. In a specific aspect, the alkenyl-substituted polyorganosiloxane comprises a vinyl-terminated polydimethylsiloxane.

The alkenyl-terminated polyorganosiloxane can be present in the first part of the curable composition in an amount of 40 to 70 weight percent or 50 to 60 weight percent, each based on the total weight of the first part of the curable composition.

In addition to the alkenyl-terminated polyorganosiloxane, the first part of the curable composition comprises an alkenyl-substituted copolyorganosiloxane. Suitable copolyorganosiloxanes substituted with an alkenyl group are generally represented by the formula:

MₐD_{b}T_{c}Q_{d},

wherein the subscripts a, b, c, and d are zero or a positive integer, subject to the limitation that if subscripts a and b are both equal to zero, subscript c is greater than or equal to two; M has the formula R₃SiO_{1/2}; D has the formula R₂SiO_{2/2}; T has the formula RSiO_{3/2}; and Q has the formula SiO_{4/2}, wherein each R group independently represents hydrogen, terminally-substituted C₁₋₆ alkenyl groups, substituted and unsubstituted monovalent hydrocarbon groups having from one to forty, or 1 to 6 carbon atoms each, subject to the limitation that at least 1, for example, at least 2, of the R groups are alkenyl R groups. Suitable alkenyl R-groups are exemplified by vinyl, allyl, 1-butenyl, 1-pentenyl, and 1-hexenyl, with vinyl being particularly useful. The alkenyl group can be bonded at the molecular chain terminals, in pendant positions on the molecular chain, or both. Preferably, the alkenyl-substituted copolyorganosiloxane is an alkenyl-diterminated polyorganosiloxane further comprising alkenyl groups in pendant positions on the molecular chain. For example, the alkenyl-substituted copolyorganosiloxane can comprise a vinyl-terminated polydimethylsiloxane having vinyl pendant groups along the polymer chain.

In an aspect, the alkenyl-substituted copolyorganosiloxane can have an alkenyl content that is higher than the alkenyl content of the alkenyl-terminated polyorganosiloxane. For example, the vinyl content of the alkenyl-substituted copolyorganosiloxane can be 0.001 to 5 weight percent, or 0.1 to 4 weight percent, or 0.5 to 4 weight percent, or 1 to 4 weight percent, or 2 to 3 weight percent.

In an aspect, the second alkenyl-substituted polyorganosiloxane has a viscosity of less than 1,000 cP, preferably 100 to 500 cP.

The alkenyl-substituted copolyorganosiloxane can be present in the first part of the curable composition in an amount of 0.1 to 10 weight percent, or 0.5 to 5 weight percent, based on the total weight of the first part.

The first part of the curable composition further comprises an alkenyl-substituted MQ polyorganosiloxane. As used herein, “MQ polyorganosiloxane” refers to a polyorganosiloxane represented by the formula:

M′ₐD′_{b}T′_{c}Q′_{d},

wherein the subscripts a, b, c, and d are zero or a positive integer, subject to the limitation that if subscripts a and b are both equal to zero, subscript c is greater than or equal to two; M has the formula R₃SiO_{1/2}; D has the formula R₂SiO_{2/2}; T has the formula RSiO_{3/2}; and Q has the formula SiO_{4/2}, wherein each R group independently represents hydrogen, terminally-substituted C₁₋₆ alkenyl groups, substituted and unsubstituted monovalent hydrocarbon groups having from one to forty, or 1 to 6 carbon atoms each, subject to the limitation that at least 1, for example, at least 2, of the R groups are alkenyl R groups. Preferably the subscripts a and d are not zero. Suitable alkenyl R-groups are exemplified by vinyl, allyl, 1-butenyl, 1-pentenyl, and 1-hexenyl, with vinyl being particularly useful. The alkenyl group can be bonded at the molecular chain terminals, in pendant positions on the molecular chain, or both. In a specific aspect, the alkenyl-substituted MQ polyorganosiloxane is a vinyl-substituted MQ polyorganosiloxane.

In an aspect, the alkenyl-substituted MQ polyorganosiloxane can have a viscosity of greater than 500 cP, for example greater than 1,000 cP, or greater than 5,000 cP, or greater than 10,000 cP. In a specific aspect, the alkenyl-terminated polyorganosiloxane can have a viscosity of 5,000 to 20,000 cP, or 10,000 to 20,000 cP.

The alkenyl-substituted MQ polyorganosiloxane can be present in the first part of the curable composition in an amount of 5 to 30 weight percent, based on the total weight of the first part of the curable composition. Within this range, the alkenyl-substituted MQ polyorganosiloxane can be present in an amount of 10 to 25 weight percent, or 15 to 20 weight percent.

The first part of the curable composition can include, generally as a component of a part containing polyorganosiloxane having at least two alkenyl groups per molecule, a cure catalyst, specifically a hydrosilylation-reaction catalyst. Effective catalysts promote the addition of silicon-bonded hydrogen onto alkenyl multiple bonds to accelerate cure. Such catalyst can include a noble metal, such as, for example, platinum, rhodium, palladium, ruthenium, iridium, or a combination thereof. The catalyst can also include a support material, such as activated carbon, aluminum oxide, silicon dioxide, polymer resin, or a combination thereof.

In an aspect, the cure catalyst can be present in amounts of up to 1,000 parts per million by weight (ppmw) of metal (e.g., platinum). In an aspect, the cure catalyst can be present in an amount of 1 to 500 ppmw, or 1 to 250 ppmw, or 1 to 100 ppmw, or 1 to 50 ppmw, or 5 to 50 ppmw, or 10 to 50 ppmw.

Platinum and platinum-containing compounds are preferred, and include, for example platinum black, platinum-on-alumina powder, platinum-on-silica powder, platinum-on-carbon powder, chloroplatinic acid, alcohol solutions of chloroplatinic acid platinum-olefin complexes, platinum-alkenylsiloxane complexes and the catalysts afforded by the microparticulation of the dispersion of the catalyst in a polymer resin such as methyl methacrylate, polycarbonate, polystyrene, silicone, and the like. A combination of different catalysts can also be used. When a platinum catalyzed system is used, poisoning of the catalyst can occur, which can cause formation of an uncured or poorly cured silicone composition that is low in strength. Additional platinum can be added, but when a large amount of platinum is added to improve cure, the pot life or working time can be adversely affected. Methyl vinyl cyclics can be used as a cure retardant, for example 1-2287 Cure Inhibitor from Dow Corning. Such materials bind the platinum at room temperature to prevent cure and hence, improve the working time, but release the platinum at higher temperatures to affect cure in the required period of time. The level of platinum and cure retardant can be adjusted to alter cure time and working time/pot life. When a higher platinum level is used, it is typically less than or equal to 100 ppmw, based on a total weight of the curable polyorganosiloxane composition. Within this range, the additional platinum concentration (i.e., the amount over that required) can be greater than or equal to 50 ppmw, or greater than or equal to 60 ppmw, based on the total weight of the curable polyorganosiloxane composition. Also within this range, the additional platinum concentration can be less than or equal to 90 ppmw, or less than or equal to 80 ppmw, based on a total weight of the curable polyorganosiloxane composition.

The cure retardant concentration (if a cure retardant is used) is less than or equal to 0.3 wt % of the total curable polyorganosiloxane composition. Within this range, the cure retardant concentration is greater than or equal to 0.005 wt %, or greater than or equal to 0.025 wt % based on the total weight of the curable polyorganosiloxane composition. Also within this range, the cure retardant concentration is less than or equal to 0.2 wt %, or less than or equal to 0.1 wt %, based on the total weight of curable composition and the required working time or pot life.

The first part of the curable composition for the manufacture of the low density cast silicone foams further includes an inorganic filler to provide a desired property, in particular filling, reinforcement, flame retardance, or a combination thereof. The inorganic filler can be in the form of a particulate material. Particles can be of any regular or irregular shape, for example, discs, fibers, flakes, platelets, rods (solid or hollow) spherical (solid or hollow), or whiskers. In an aspect, the particles are of an irregular spherical form. The median diameter (which as defined herein can mean equivalent spherical diameter) of each of the particulate fillers can be 0.1 μm (micrometer) to 1 millimeter (mm), or 0.5 to 500 μm, or 1 to 50 μm. The particulate material can optionally exhibit a multimodal distribution of median particle sizes. A multimodal distribution can be a result of using two different particulate materials, or a single material with two or more size modes.

Suitable inorganic fillers can include, for example, a ceramic, a clay, a silicate, a plurality of ceramic or glass microspheres. Specific particulate materials can include alumina, aluminum trihydrate, aluminum nitride, aluminum silicate, barium titanate, beryllia, boron nitride, borates (e.g., zinc borate, sodium borate, and the like, and hydrates thereof), calcium carbonate, clay, kaolin, corundum, magnesia, magnesium hydroxide, glass, mica, nanoclay, quartz, silicon carbide, strontium titanate, talc, titanium dioxide (such as rutile and anatase), wollastonite, and the like, or a combination thereof. In an aspect the filler comprises a flame retardant, such as aluminum trihydrate. In a specific aspect, the inorganic filler can comprise aluminum trihydrate and at least one of silica or calcium carbonate.

Inorganic fillers can optionally have an exterior surface chemically modified by treatment with a coupling agent. The coupling agent can be a silane or epoxy, for example, an organosilane having, at one end, a group that can react with hydroxyl groups present on the exterior surface of the particulate filler and, on the other end, an organic group that will aid in dispersibility of the particulate filler in a polymer matrix (e.g., the silicone foam). A difunctional silane coupling can have a combination of groups such as vinyl, hydroxy, and amino groups, for example, 3-amino-propyltricthoxy silane. Silane coatings can also minimize water absorption.

The inorganic filler can be present in the first part of the curable composition in an amount of 3 to 35 weight percent, or 10 to 30 weight percent, or 15 to 28 weight percent, each based on the total weight of the first part of the curable composition.

The curable composition for the manufacture of the low density cast silicone foam further comprises a chemical blowing agent. In an aspect, a physical blowing agent is excluded from the curable composition. The chemical blowing agent comprises water, a silanol-terminated polyorganosiloxane, and optionally, an alcohol (which includes diols, triols, and the like) having from 1 to 16 carbon atoms. The silanol-terminated polyorganosiloxane can have a viscosity of 20 to 40,000 cP, or 400 to 2,000 cP, or 500 to 1,000 cP. In a specific aspect, the silanol-terminated polyorganosiloxane comprises hydroxyl-terminated polydimethylsiloxane. In an aspect, the alcohol preferably comprises a C₁₋₁₂ alcohol, or a C₁₋₆ alcohol. In a specific aspect, the alcohol comprises 1-butanol. In an aspect, the alcohol may consist of a monoalcohol. Accordingly, in some aspects, polyols (e.g., diols, triols, and the like) can be excluded from the curable composition.

In an aspect, the chemical blowing agent comprises water, a C₁₋₁₂ monoalcohol, and the silanol-terminated polyorganosiloxane. For example, the chemical blowing agent can comprise 0.1 to 0.6 weight percent water, 0.1 to 0.9 weight percent of the C₁₋₁₂ monoalcohol; and 0.4 to less than 1 weight percent of the silanol-terminated polyorganosiloxane; each based on the total weight of the first part of the curable composition.

In an aspect, the chemical blowing agent comprises water and the silanol-terminated polyorganosiloxane. For example, the chemical blowing agent can comprise greater than 0.5 weight percent water, and 0.08 to less than 1 weight percent of the silanol-terminated polyorganosiloxane, each based on the total weight of the first part of the curable composition.

In an aspect, the chemical blowing agent can further comprise a monocarbinol-substituted polyorganosiloxane, a monofunctional-silanol, or both. In a specific aspect, the chemical blowing agent comprises the silanol-terminated polyorganosiloxane, water, an alcohol (e.g., butanol), and the monocarbinol-substituted polyorganosiloxane.

The chemical blowing agent can be present in the composition in a total amount of 0.1 to 2.5 weight percent, based on the total weight of the first part of the curable composition. The silanol-terminated polyorganosiloxane can generally be included in the first part of the composition in an amount of 0.01 to less than 1 weight percent, or 0.4 to less than 1 weight percent, based on the total weight of the first part of the curable composition.

The curable composition further comprises a second part. The second part comprises a co-curable hydride-substituted polyorganosiloxane. The hydride-substituted polyorganosiloxane can have at least two silicon-bonded hydrogen atoms per molecule, and is generally represented by the formula:

M″ₐD″_{b}T″_{c}Q″_{d}

wherein the subscripts a, b, c, and d are zero or a positive integer, subject to the limitation that if subscripts a and b are both equal to zero, subscript c is greater than or equal to two; M″ has the formula R₃SiO_{1/2}; D″ has the formula R₂SiO_{2/2}; T″ has the formula RSiO_{3/2}; and Q″ has the formula SiO_{4/2}, wherein each R group independently represents hydrogen, substituted and unsubstituted monovalent hydrocarbon groups having from one to forty, or one to six carbon atoms each, subject to the limitation that at least two of the R groups are hydrogen. For example, each of the R groups of the polyorganosiloxane having at least two silicon-bonded hydrogen atoms per molecule are independently selected from hydrogen, methyl, ethyl, propyl, butyl, pentyl, hexyl, aryl, phenyl, tolyl, xylyl, aralkyl, benzyl, phenethyl, halogenated alkyl, 3-chloropropyl, 3,3,3-trifluoropropyl, or a combination thereof. Methyl and phenyl can be preferred.

The hydrogen can be bonded to silicon at the molecular chain terminals, in pendant positions on the molecular chain, or both. In an aspect, the hydrogens are substituted at terminal positions. In an aspect, at least 3 to 4 hydrogens are present per molecule. The hydrogen-containing polyorganosiloxane component can have straight chain, partially branched straight chain, branched-chain, cyclic, or network molecular structure, or can be a mixture of two or more different polyorganosiloxanes with the exemplified molecular structures.

The hydride-containing polyorganosiloxane can comprise, for example, trimethylsiloxy-endblocked methylhydrogenpolysiloxanes; trimethylsiloxy-endblocked dimethylsiloxane-methylhydrogensiloxane copolymers; trimethylsiloxy-endblocked methylhydrogensiloxane-methylphenylsiloxane copolymers; trimethylsiloxy-endblocked dimethylsiloxane-methylhydrogensiloxane-methylphenylsiloxane copolymers; dimethylhydrogensiloxy-endblocked dimethylpolysiloxanes; dimethylhydrogensiloxy-endblocked methylhydrogenpolysiloxanes; dimethylhydrogensiloxy-endblocked dimethylsiloxanes-methylhydrogensiloxane copolymers; dimethylhydrogensiloxy-endblocked dimethylsiloxane-methylphenylsiloxane copolymers; and dimethylhydrogensiloxy-endblocked methylphenylpolysiloxanes. In a specific aspect, the hydride-substituted polyorganosiloxane comprises a trimethylsiloxy-endblocked methylhydrogenpolysiloxane.

In an aspect, the silicone hydride-containing crosslinker can have a hydride content ranging from 0.02 to 10 percent by weight and a viscosity ranging from 10 to 10,000 centipoise at 25° C. In a specific aspect, the hydride-substituted polyorganosiloxane comprises a trimethylsiloxy-endblocked methylhydrogenpolysiloxane having a hydride content of 0.1 to 5 weight percent, or 0.5 to 2 weight percent, or 1 to 2 weight percent. In a specific aspect, the hydride-substituted polyorganosiloxane comprises a trimethylsiloxy-endblocked methylhydrogenpolysiloxane having a viscosity of 10 to 50 cP, or 10 to 30 cP, or 15 to 30 cP, or 20 to 30 cP. In yet another specific aspect, the hydride-substituted polyorganosiloxane comprises a trimethylsiloxy-endblocked methylhydrogenpolysiloxane having a hydride content of 0.1 to 5 weight percent, or 0.5 to 2 weight percent, or 1 to 2 weight percent and a viscosity of 10 to 50 cP, or 10 to 30 cP, or 15 to 30 cP, or 20 to 30 cP.

The hydride-substituted polyorganosiloxane component is used in an amount sufficient to cure the composition, for example, in a quantity that provides a molar ratio of hydride groups to a sum of vinyl and hydroxyl groups of 1.1 to 2.5.

In an aspect, the hydride-substituted polyorganosiloxane component can be provided with a carrier fluid. The carrier fluid is preferably a polyorganosiloxane, for example having the structure

MₐD_{b}T_{c}Q_{d},

wherein M, D, T, Q and the subscripts a, b, c, and d are as previously defined. In an aspect, the carrier fluid can comprise a second alkenyl-terminated polyorganosiloxane, which may be the same or different from the alkenyl-terminated polyorganosiloxane described previously. For example, the second alkenyl-terminated polyorganosiloxane may be different from the alkenyl-terminated polyorganosiloxane described previously in chemical composition, viscosity, or both. In an aspect the second alkenyl-terminated polyorganosiloxane may be different from the alkenyl-terminated polyorganosiloxane described previously in viscosity. Preferably, the second alkenyl-terminated polyorganosiloxane is an alkenyl-diterminated polyorganosiloxane, wherein two of the chain ends are alkenyl groups. As used herein, a vinyl group is a group having the formula —CH═CH₂, and a “substituted vinyl group” has the formula —CH═CR₂, where the R groups can be independently hydrogen or C₁₋₆ alkyl groups. The vinyl concentration in the second alkenyl-terminated polyorganosiloxane can be, for example 0.001 to 1 weight percent, or 0.01 to 0.5 weight percent, or 0.01 to 0.15 weight percent, or 0.01 to 0.1 weight percent.

In an aspect, the carrier fluid can comprise a second alkenyl-terminated polyorganosiloxane having a viscosity of greater than 500 cP, for example greater than 1,000 cP, or greater than 5,000 cP. In a specific aspect, the second alkenyl-terminated polyorganosiloxane can have a viscosity of 500 to 10,000 cP.

When included in a carrier fluid, the hydride-substituted polyorganosiloxane component can be present in the carrier fluid in a weight ratio of 10:90 to 90:10, or 50:50 to 85:15, or 60:40 to 70:30.

Other additives can be present in either part of the curable compositions, for example, an ultraviolet (UV) stabilizer, antistatic agent, dye, pigment, antimicrobial or antiviral agent, and the like, or a combination thereof. When additives are present, the amounts used are selected so that the desired properties of the cured silicone composition are not adversely affected by the presence of the additives.

The curable silicone composition can be manufactured by combining the various components in any suitable order. In an aspect, the components including the alkenyl-terminated polyorganosiloxane, the alkenyl-substituted copolyorganosiloxane, the alkenyl-substituted MQ polyorganosiloxane, catalyst, fillers, and chemical blowing agents are mixed as a first part (also referred to herein as “Part A”), then combined with the hydride-containing polyorganosiloxane as a second part (also referred to herein as “Part B”). In an aspect, a weight ratio of Part A and Part B is 6:1 to 25:1, or 9:1 to 20:1, or 9:1 to 15:1, or 9:1 to 12:1.

The parts can be metered, mixed, and cast onto a coating line, for example a continuous coating line. The blowing (foaming) and curing then occurs on the coating line.

A cured silicone foam layer can be formed by casting the curable composition followed by curing the cast composition. The present inventors have surprisingly discovered that the curable compositions can provide unexpectedly low densities in cast silicone foams. Post-cure can be used to advance cure to near complete status, developing desirable physical properties.

Liquid material inputs Part A and Part B of the curable composition can be mixed and cast onto a moving release layer. In an aspect, another release layer is pulled through on top of the cast mixture and the sandwiched mixture is then passed through the nip of two rotating rollers to meter the amount of the curable composition, which determines the thickness of the partially cured foam, and ultimately, the final foam. The gap thickness between the rolls (i.e., the nip gap) can be adjusted to decrease the thickness of the sandwiched mixture as it passes between them. In an aspect, the nip gap can be, for example, 0.005 to 0.5 inch (0.127 to 12.7 millimeters), or 0.01 to 0.1 inches (0.254 to 2.54 mm), or 0.01 to 0.05 inches (0.254 to 1.27 mm), or 0.02 to 0.04 inches (0.508 to 1.016 mm). During the metering step, the width of the sandwiched mixture can be maintained, but the length of the sandwiched mixture can increase as the thickness decreases. In another aspect, a second release layer on top of the cast mixture and rollers are not used, and a process such as knife-over-roll can be used to determine the thickness of the partially cured foam, and ultimately, the final foam.

The coated release layer passes through an oven, which can be heated by at least one platen, by heated air, other means, or a combination thereof to foam and at least partially cure the cast composition. Two or more curing ovens at the same or different temperatures can be used. Temperatures in the oven(s) can be 80 to 200° F. (43.3 to 60° C.) and residence time for the coated carrier in the oven(s) can be varied to achieve the desired level of cure. Upon exiting the oven, when an additional top layer of carrier film is used, the additional top layer can be removed.

It has been found that only certain carriers provide adequate adhesion to the release layer. For example, it has been found that sufficient adhesion to polycarbonate is not obtained under the above-described cure conditions, such that further processing is not practicable. It has also been found that excessive adhesion to the release layer occurs when the above-described process conditions are not used. A suitable carrier for used with the above-described cure conditions is a polyester (such as polyethylene terephthalate, polyethylene naphthalate, polybutylene terephthalate, or polybutylene naphthalate). Polyethylene terephthalate is preferred. It may be possible to adjust processing conditions to achieve effective adhesion with other release layers, for example polyolefin (such as polyethylene, polypropylene, or ethylene-propylene copolymer), polyvinyl alcohol, polyvinylidene chloride, polyvinyl chloride, vinyl chloride-vinyl acetate copolymer, polyvinyl acetate, polyamide, polyimide, cellulose, fluorinated resin, polyether, polystyrene resin (such as polystyrene), polycarbonate, polyether sulfone, or a combination thereof. In an aspect, the substrate includes polyethylene terephthalate.

The foam can be rolled on a drum for storage and optional heating/post-curing, for example at a temperature of 100 to 300° F. (65.6 to 121.1° C.) for 6 to 48 hours. Post-cure is especially useful to lower compression set, eliminate volatile compounds, and complete cure if needed.

As discussed previously, an advantage of the present disclosure is that the curable compositions described herein do not rely on the addition of a fluorinated surfactant in order to achieve the desired low density cast silicone foam. The curable compositions (and therefore the resulting cured silicone foams) comprise less than 0.1 weight percent, or less than 0.01 weight percent of a fluorinated surfactant, based on the total weight of the curable composition. In an aspect, fluorinated surfactants are excluded from the curable composition. In an aspect, the cured silicone foam prepared from the curable composition described herein comprises less than 0.1 weight percent, or less than 0.01 weight percent of a fluorinated surfactant, based on the total weight of the foamed product. Fluorine concentration can be determined, for example, by energy dispersive x-ray spectroscopy (EDS or EDX). In an aspect, no fluorine is detectable by energy dispersive x-ray spectroscopy in the foamed product.

In a further advantageous feature, additional solvents, including aqueous buffered solutions are not needed for the curable composition. Accordingly, additional solvent or aqueous buffered solutions can be present in the curable composition in an amount of less than 0.1 weight percent, or less than 0.01 weight percent, based on the total weight of the curable composition. In an aspect, additional solvent or aqueous buffered solution is excluded from the curable composition. In an aspect, the pH of the curable composition is not above 9, preferably not above 8.

The silicone foam obtained from the curable composition of the present disclosure is a low density cast silicone foam. The low density cast silicone foam according to the present disclosure has a density of less than 240 kilograms per cubic meter (kg/m³) (15 pounds per cubic foot). The term “foam” as used herein refers to materials having a cellular structure, i.e., a void content. The foams produced by this method have primarily closed cells. For example, the low density cast silicone foams can have a closed cell content of at least 50%, or at least 60%. Cell morphology can be characterized, for example, using various microscopy techniques, for example optical microscopy or scanning electron microscopy. The low density cast foams are thin foams, for example, having a thickness of less than 1.5 inches (38.1 millimeters), or less than 0.25 inches (6.35 millimeters), or 0.05 to 1.5 inches (1.27 to 38.1 millimeters), or 0.05 to 1 inch (1.27 to 25.4 millimeters), or 0.05 to 0.75 inches (1.27 to 19.05 millimeters), or 0.05 to 0.5 inches (1.27 to 12.7 millimeters), or 0.05 to 0.25 inches (1.27 to 6.35 millimeters), or 0.075 to 0.2 inches (1.905 to 5.08 millimeters), or 0.08 to 0.15 inches (2.032 to 3.81 millimeters).

The low density cast silicone foams can advantageously maintain their elastic behavior over many cycles of compression deflection over the life of the foam, properties reflected by compressive force deflection and compression set of the foam. Foams with good compression set resistance provide cushioning and maintain their original shape or thickness under loads for extended periods. In an aspect, the silicone foam has a compression force deflection (CFD) of 0.4 to 10 pounds per square inch (psi (2.76 to 68.9 kilopascals (kPa)), or 1 to 10 psi (6.9 to 68.9 kPa), or 1 to 5 psi (6.9 to 34.5 kPa), or 0.4 to 5 psi (2.76 to 34.5 kPa), each at 25% deflection and determined in accordance with ASTM D3574-17. The silicone foam can have a compression set of 0 to 5%, determined in accordance with ASTM D1056-20 B2.

In another advantageous feature, the low density cast silicone foam can have low water absorption, for example a water absorption of less than 5 wt %, or less than 3 wt %, or less than 2 wt %, as determined by heating a sample at 50° C. for 24 hours, then submersing the sample in water for 30 seconds at room temperature, and determining the weight of the water absorbed. In an aspect water absorption can be determined by cutting a sample size of 100 mm×100 mm sample, storing at 50° C. at least 24 hours, then weighing the sample as W1. The sample is immersed into water at room temperature for 30 seconds, and remove from the water. Water is removed from the surface of the sample, and its weight recorded as W2. Percent water absorption is calculated using the equation ((W2−W1)/W1)*100.

The silicone foam is especially useful for sealing, vibration management, sound management, pressure management, or a combination thereof, in a wide variety of applications, including transportation and aerospace.

Accordingly, an aspect of the present disclosure is a curable composition for preparing a low density cast silicone foam comprising: a first part comprising, based on the total weight of the first part: 40 to 70 weight percent of an alkenyl-terminated polyorganosiloxane; 0.1 to 10 weight percent of an alkenyl-substituted copolyorganosiloxane; 5 to 30 weight percent of an alkenyl-substituted MQ polyorganosiloxane; a cure catalyst; an inorganic filler; and 0.1 to 1.5 weight percent of a chemical blowing agent comprising water, a silanol-terminated polyorganosiloxane; and optionally, an alcohol; and a second part comprising a hydride-substituted polyorganosiloxane. The low density cast silicone foam has a density of less than 240 kg/m³. The low density cast silicone foam has a closed cell content of at least 50%. In an aspect, the first part comprises, based on the total weight of the first part: 50 to 60 weight percent of the alkenyl-terminated polyorganosiloxane; 0.5 to 5 weight percent of the alkenyl-substituted copolyorganosiloxane; 10 to 25 weight percent, or 15 to 20 weight percent of the alkenyl-substituted MQ polyorganosiloxane; the cure catalyst; 3 to 35 weight percent, or 10 to 30 weight percent, or 15 to 28 weight percent, of the inorganic filler; and the chemical blowing agent comprising water, alcohol, and 0.4 to less than 1 weight percent of the silanol-terminated polyorganosiloxane. The first part and the second part can be mixed together to provide the curable composition. The alkenyl-terminated polyorganosiloxane can comprise a vinyl-diterminated polydimethysiloxane, preferably having a viscosity of greater than 10,000 cP, preferably a viscosity of 50,000 to 70,000 cP. The alkenyl-substituted copolyorganosiloxane can comprise a vinyl-diterminated polydimethylsiloxane comprising vinyl pendent groups, preferably having a viscosity of less than 1,000 cP, preferably 100 to 500 cP. The cure catalyst can comprise platinum. The chemical blowing agent can comprise water, a C₁₋₁₂ monoalcohol, and the silanol-terminated polyorganosiloxane, preferably wherein the C₁₋₁₂ monoalcohol is butanol. The chemical blowing agent can comprise 0.1 to 0.6 weight percent water, 0.1 to 0.9 weight percent of the C₁₋₁₂ monoalcohol; and 0.4 to less than 1 weight percent of the silanol-terminated polyorganosiloxane; each based on the total weight of the first part of the curable composition. The chemical blowing agent can comprise greater than 0.5 weight percent water, and 0.08 to less than 1 weight percent of the silanol-terminated polyorganosiloxane. The curable composition can further comprise a monocarbinol-substituted polyorganosiloxane or a monofunctional-silanol. The low density cast silicone foam can have a thickness of less than 1.5 inches (38.1 millimeters), or less than 0.25 inches (6.35 millimeters). The curable composition can comprise a molar ratio of hydride groups to a sum of vinyl and hydroxyl groups of 1.1 to 2.5. The curable composition can be made by a method comprising: combining the alkenyl-terminated polyorganosiloxane, the alkenyl-substituted copolyorganosiloxane, the alkenyl-substituted MQ polyorganosiloxane, the cure catalyst, the inorganic filler, and the chemical blowing agent to provide the first part; and combining the first part with the second part comprising the hydride-substituted polyorganosiloxane to provide the curable composition. The first part and the second part can be combined a weight ratio of first part:second part of 6:1 to 25:1, or 9:1 to 20:1, or 9:1 to 15:1, or 9:1 to 12:1. A fluorinated surfactant can be present in an amount of less than 0.1 weight percent based on the total weight of the curable composition. Preferably a fluorinated surfactant is excluded from the curable composition. A cured silicone foam layer comprises a cured product of the curable composition.

In an aspect, a method for forming a silicone foam sheet comprises casting the curable composition onto a first release layer; placing a second release layer on a side of the cast curable composition opposite the first release liner to form a multilayer structure; and passing the cast curable composition on the substrate through the nip of two rotating rollers to meter the amount of curable composition; and curing the curable composition to form the silicone foam sheet. The method can further comprise combining the alkenyl-terminated polyorganosiloxane, the alkenyl-substituted copolyorganosiloxane, the alkenyl-substituted MQ polyorganosiloxane, the cure catalyst, the inorganic filler, and the chemical blowing agent to provide the first part; and combining the first part with the second part comprising the hydride-substituted polyorganosiloxane to provide the curable composition. The first part and the second part can be combined in a weight ratio of first part:second part of 6:1 to 25:1, or 9:1 to 20:1, or 9:1 to 15:1, or 9:1 to 12:1. A silicone foam sheet formed according to the method described herein can have a thickness of 0.05 to 1.5 inches (1.27 to 38.1 millimeters), or 0.05 to 1 inch (1.27 to 25.4 millimeters), or 0.05 to 0.75 inches (1.27 to 19.05 millimeters), or 0.05 to 0.5 inches (1.27 to 12.7 millimeters), or 0.05 to 0.25 inches (1.27 to 6.35 millimeters), or 0.075 to 0.2 inches (1.905 to 5.08 millimeters), or 0.08 to 0.15 inches (2.032 to 3.81 millimeters). The silicone foam sheet can have a closed cell content of at least 50%. The silicone foam sheet can have a density of less than 240 kg/m³. The silicone foam sheet can have a compression force deflection of 1 to 5 pounds per square inch at 25% deflection and determined in accordance with ASTM D1056-20 B2.

This disclosure is further illustrated by the following examples, which are non-limiting.

### EXAMPLES

Materials used in the following examples are described in Table 1.

TABLE 1

| Component | Description | Supplier |
|---|---|---|
| Polyor- | Vinyl-terminated | Elkem |
| ganosiloxane A | polydimethylsiloxane, having a | |
| | viscosity of 60,000 cP, a degree | |
| | of polymerization of 900, and | |
| | a vinyl content of 0.08 wt %, | |
| | obtained as BLUESIL FLD621 | |
| Polyor- | MQ polydimethylsiloxane having | Elkem |
| ganosiloxane B | pendent vinyl groups in a vinyl- | |
| | terminated polydimethylsiloxane | |
| | carrier (25:75 by weight), having | |
| | a vinyl content of 1 wt % and a | |
| | viscosity of 15,000 cP, obtained | |
| | as BLUESIL 11342 | |
| Polyor- | Vinyl-terminated | Elkem |
| ganosiloxane C | polydimethylsiloxane copolymer | |
| | having pendent vinyl groups, | |
| | having a vinyl content of 2.5 | |
| | wt %, a viscosity of 390 cP, | |
| | and approximately 5% of the | |
| | repeating units bearing a | |
| | vinyl functionality, obtained | |
| | as BLUESIL FLD 50620W | |
| Polyor- | Hydroxyl terminated | Elkem |
| ganosiloxane D | polydimethylsiloxane, having a | |
| | viscosity of 750 cP and a hydroxyl | |
| | content of 0.22 wt %, obtained as | |
| | BLUESIL FLD 48V750 | |
| Polyor- | Trimethyl terminated MeHSiO siloxane | Elkem |
| ganosiloxane E | polymer having a hydride content of | |
| | 1.5 wt %, a viscosity of 25 cP, | |
| | obtained as WR-68, in a vinyl- | |
| | terminated polydimethylsiloxane | |
| | carrier, having a vinyl content of | |
| | 0.25 wt % and a viscosity of 2000 | |
| | cP, obtained as BLUESIL FLDV2000 | |
| | (65:35 weight ratio of trimethyl | |
| | terminated MeHSiO siloxane | |
| | polymer:carrier) | |
| DI water | Deionized Water | |
| BuOH | 1-Butanol | |
| Carbinol- | Monocarbinol terminated | Gelest |
| PDMS | polydimethylsiloxane, having a viscosity | |
| | of 250 cP and a hydroxyl content of | |
| | 0.17 wt %, obtained as MCR-C22 | |
| ATH | Aluminum trihydrate, obtained as | Huber |
| | MICRAL 855 | Materials |
| Calcium | Calcium Carbonate, obtained as | Imerys |
| Carbonate | WINNOFIL SPM | Performance |
| | | Minerals |
| Silica | Silica, obtained as IMSIL A-8 | Sibelco |
| Pt Catalyst | [1,3-Bis(2,6- | Umicore |
| | diisopropylphenyl)imidazol-2- | |
| | ylidene][1,3-divinyl-1,1,3,3- | |
| | tetramethyldisiloxane]platinum(0), | |
| | obtained as Umicore HS245 Pt catalyst | |
| | solution (10%) | |

The following general mixing protocol was used to prepare the foam of the present examples.

A first foam precursor mixture was prepared by adding polyorganosiloxane A, polyorganosiloxane B, polyorganosiloxane C, polyorganosiloxane D, DI water, Pt catalyst, and, when present, BuOH and optionally carbinol-PDMS to a mixing cup. The mixture was mixed in a FlackTek speedmixer at 2000 revolutions per minute (rpm) for 30 seconds(s). To this mixture, the filler (ATH, calcium carbonate, silica), were added in sequence. The mixture was mixed in the speedmixer according to the following protocol: 2100 rpm for 8 s, 2300 rpm for 8 s, 2500 rpm for 10 s, 2650 rpm for 8 s, and 2750 rpm for 8 s. After mixing, the cup was removed and cooled to 40° F. (4.4° C.).

A second foam precursor mixture was prepared by providing polyorganosiloxane E by mixing the trimethyl terminated MeHSiO siloxane polymer with the vinyl carrier in a 65:35 weight ratio.

The first foam precursor mixture and the second foam precursor mixture were combined in a 10:1 weight ratio of first precursor:second precursor. After manually mixing the two components thoroughly for 35 s, the mixed composition was dispensed as quickly as possible on a thin polyethylene terephthalate (PET) sheet (4 mil (0.1016 millimeters (mm))) and drawn between rollers having a nip gap set at 25 mil (0.025 inches (in); 0.635 mm). The resulting foamed material sandwiched between the two PET films was placed in a convection oven set at 60° C. for 3 minutes and then additionally for 2 minutes for further progressing the cure. After a total of 5 minutes, the cast material was peeled off from the backing PET films. The thickness of the foam was then measured, and expansion calculated. After 24 hours (h), the delaminated foamed sheet was placed in convection oven set at 100° C. for 24 h for post-curing. Post-cured foam was then characterized for density, compression deflection (25%), and compression set (22 h, 100° C.) (ASTM D1056-20 B2). Cell morphology was characterized using optical microscopy or scanning electron microscopy.

The amounts of the components used to prepare the foam for each example are provided in Table 2, reported as weight fraction based on the total weight of the first foam precursor mixture. Table 2 also shows the characterization of each foamed example.

TABLE 2

| | | | | | | | | |
|---|---|---|---|---|---|---|---|---|
| CE1 | CE2 | CE3 | CE4 | E1 | E2 | E3 | E4* | CE5* |

Part A

| | | | | | | | | | |
|---|---|---|---|---|---|---|---|---|---|
| Polyorgano-siloxane A | 0.547 | 0.544 | 0.543 | 0.54 | 0.543 | 0.54 | 0.54 | 0.544 | 0.545 |
| Polyorgano-siloxane B | 0.172 | 0.171 | 0.171 | 0.17 | 0.171 | 0.17 | 0.17 | 0.171 | 0.171 |
| Polyorgano-siloxane C | 0.021 | 0.021 | 0.021 | 0.021 | 0.021 | 0.021 | 0.02 | 0.021 | 0.021 |
| Polyorgano-siloxane D | 0.006 | 0.006 | 0.006 | 0.006 | 0.006 | 0.006 | 0.006 | 0.009 | 0.01 |
| DI water | 0.005 | 0.005 | 0.005 | 0.005 | 0.005 | 0.005 | 0.005 | 0.007 | 0.0048 |
| BuOH | | 0.004 | 0.006 | 0.012 | 0.006 | 0.006 | 0.006 | 0 | 0 |
| Carbinol-PDMS | | 0 | 0 | 0 | 0 | 0.006 | 0.01 | 0 | 0 |
| ATH | 0.115 | 0.114 | 0.114 | 0.114 | 0.114 | 0.114 | 0.114 | 0.115 | 0.116 |
| Calcium Carbonate | 0.0156 | 0.016 | 0.016 | 0.016 | 0.016 | 0.016 | 0.014 | 0.016 | 0.0161 |
| Silica | 0.118 | 0.117 | 0.117 | 0.116 | 0.117 | 0.116 | 0.116 | 0.117 | 0.117 |
| Pt Cat. | 0.000129 | 0.000128 | 0.000128 | 0.000127 | 0.000128 | 0.000127 | 0.000127 | 0.000128 | 0.000129 |

Part B

| | | | | | | | | | |
|---|---|---|---|---|---|---|---|---|---|
| Part A:Polyorgano-siloxane E | 10:1 | 10:1 | 10:1 | 10:1 | 10:1 | 10:1 | 10:1 | 10:1 | 10:1 |

Processing

| | | | | | | | | | |
|---|---|---|---|---|---|---|---|---|---|
| Hydride to (vinyl + hydroxyl ratio) | 1.45 | 1.42 | 1.41 | 1.38 | 1.41 | 1.40 | 1.38 | 1.35 | 1.41 |
| Nip gap (mil) | | 25 | 25 | 25 | 35 | 35 | 35 | 25 | 25 |

Properties

| | | | | | | | | | |
|---|---|---|---|---|---|---|---|---|---|
| Thickness (inch) | 0.07 | 0.078 | 0.088 | 0.082 | 0.128 | 0.131 | 0.134 | 0.093 | 0.087 |
| Expansion | 2.83 | 3.71 | 4.19 | 3.9 | 4.13 | 4.22 | 4.32 | 4.42 | 4.19 |
| Density (pcf) | 22.56 | 18.6 | 17 | 18.1 | 12.9 | 11.5 | 10.9 | 11.3 | 19.49 |
| Improvement in density from CE1 (%) | — | 17 | 24 | 20 | 42 | 49 | 51 | 50 | 14 |
| CFD 25% (psi/kPa) | 9.2/63.4 | 6.7/46.2 | 4.4/30.3 | 4.8/33.1 | 3.5/24.1 | 3.2/22.1 | 3.1/21.3 | 2.5/17.2 | |
| Compression set (%) | 1.7 | | 1.3 | | 1.4 | 1.1 | 1.0 | | |
| Cell morphology | Partially | Partially | Partially | Mostly | Partially | Partially | Closed | Closed | Closed |
| | closed | closed | closed | open | closed | closed | | | |

*The processing conditions were as follows for these compositions: 60° C. for 4 min, followed by 100° C. for 2 min as the cure protocol. Subsequent 24 h at 100° C. post-cure protocol is as described for other examples.

As shown in Table 2, a particular combination of components in particular amounts can provide the desired cast foams having a low density (i.e., less than 15 pcf (240 kilograms per cubic meter)). Advantageously, examples 2 and 3 show that the density can be further lowered (relative to example 1) by including a combination of DI water, BuOH, and carbinol-PDMS. Comparative Example 4 and Example 1 show that increasing the amount of BuOH can undesirably increase the density of the cast foam. Interestingly, example 4 shows that DI water can be used alone as a chemical blowing agent (i.e., no BuOH present), provided that the amounts of water and hydroxyl-substituted polyorganosiloxane are increased to account for the lack of BuOH. Comparative example 5 shows that even small adjustments to the components of the curable composition can affect the final properties of the cast silicone foam.

This disclosure further encompasses the following aspects.

Aspect 1: A curable composition for preparing a low density cast silicone foam comprising: a first part comprising, based on the total weight of the first part: 40 to 70 weight percent of an alkenyl-terminated polyorganosiloxane; 0.1 to 10 weight percent of an alkenyl-substituted copolyorganosiloxane; 5 to 30 weight percent of an alkenyl-substituted MQ polyorganosiloxane; a cure catalyst; an inorganic filler; and 0.1 to 1.5 weight percent of a chemical blowing agent comprising water, a silanol-terminated polyorganosiloxane; and optionally, an alcohol; and a second part comprising a hydride-substituted polyorganosiloxane; wherein the low density cast silicone foam has a density of less than 240 kg/m³; and wherein the low density cast silicone foam has a closed cell content of at least 50%.

Aspect 2: The curable composition of aspect 1, wherein the first part comprises, based on the total weight of the first part: 50 to 60 weight percent of the alkenyl-terminated polyorganosiloxane; 0.5 to 5 weight percent of the alkenyl-substituted copolyorganosiloxane; 10 to 25 weight percent, or 15 to 20 weight percent of the alkenyl-substituted MQ polyorganosiloxane; the cure catalyst; 3 to 35 weight percent, or 10 to 30 weight percent, or 15 to 28 weight percent, of the inorganic filler; and the chemical blowing agent comprising water, alcohol, and 0.4 to less than 1 weight percent of the silanol-terminated polyorganosiloxane.

Aspect 3: The curable composition of aspect 1 or 2, wherein the first part and the second part are mixed together to provide the curable composition.

Aspect 4: The curable composition of any of aspects 1 to 3, wherein the alkenyl-terminated polyorganosiloxane comprises a vinyl-diterminated polydimethysiloxane, preferably having a viscosity of greater than 10,000 cP, preferably a viscosity of 50,000 to 70,000 cP.

Aspect 5: The curable composition of any of aspects 1 to 4, wherein the alkenyl-substituted copolyorganosiloxane comprises a vinyl-diterminated polydimethylsiloxane comprising vinyl pendent groups, preferably having a viscosity of less than 1,000 cP, preferably 100 to 500 cP.

Aspect 6: The curable composition of any of aspects 1 to 5, wherein the cure catalyst comprises platinum.

Aspect 7: The curable composition of any of aspects 1 to 6, wherein the inorganic filler comprises aluminum trihydrate.

Aspect 8: The curable composition of any of aspects 1 to 7, wherein the chemical blowing agent comprises water, a C₁₋₁₂ monoalcohol, and the silanol-terminated polyorganosiloxane, preferably wherein the C₁₋₁₂ monoalcohol is butanol.

Aspect 9: The curable composition of aspect 8, wherein the chemical blowing agent comprises: 0.1 to 0.6 weight percent water, 0.1 to 0.9 weight percent of the C₁₋₁₂ monoalcohol; and 0.4 to less than 1 weight percent of the silanol-terminated polyorganosiloxane; each based on the total weight of the first part of the curable composition.

Aspect 10: The curable composition of any of aspects 1 to 7, wherein the chemical blowing agent comprises: greater than 0.5 weight percent water, and 0.08 to less than 1 weight percent of the silanol-terminated polyorganosiloxane.

Aspect 11: The curable composition of any of aspects 1 to 10, wherein the curable composition further comprises a monocarbinol-substituted polyorganosiloxane or a monofunctional-silanol.

Aspect 12: The curable composition of any of aspects 1 to 11, wherein the low density cast silicone foam has a thickness of less than 1.5 inches (38.1 millimeters), or less than 0.25 inches (6.35 millimeters).

Aspect 13: The curable composition of any of aspects 1 to 12, wherein curable composition comprises a molar ratio of hydride groups to a sum of vinyl and hydroxyl groups of 1.1 to 2.5.

Aspect 14: The curable composition of any of aspects 1 to 13, wherein the curable composition is made by a method comprising: combining the alkenyl-terminated polyorganosiloxane, the alkenyl-substituted copolyorganosiloxane, the alkenyl-substituted MQ polyorganosiloxane, the cure catalyst, the inorganic filler, and the chemical blowing agent to provide the first part; and combining the first part with the second part comprising the hydride-substituted polyorganosiloxane to provide the curable composition.

Aspect 15: The curable composition of aspect 14, wherein the first part and the second part are combined a weight ratio of first part:second part of 6:1 to 25:1, or 9:1 to 20:1, or 9:1 to 15:1, or 9:1 to 12:1.

Aspect 16: The curable composition of any of aspects 1 to 15, wherein a fluorinated surfactant is present in an amount of less than 0.1 weight percent based on the total weight of the curable composition, preferably wherein a fluorinated surfactant is excluded from the curable composition.

Aspect 17: A cured silicone foam layer comprising a cured product of the curable composition of any of aspects 1 to 16.

Aspect 18: A method for forming a silicone foam sheet, the method comprising: casting the curable composition of any of aspects 1 to 16 onto a first release layer; placing a second release layer on a side of the cast curable composition opposite the first release liner to form a multilayer structure; passing the cast curable composition on the substrate through the nip of two rotating rollers to meter the amount of curable composition; and curing the curable composition to form the silicone foam sheet.

Aspect 19: The method of aspect 18, further comprising: combining the alkenyl-terminated polyorganosiloxane, the alkenyl-substituted copolyorganosiloxane, the alkenyl-substituted MQ polyorganosiloxane, the cure catalyst, the inorganic filler, and the chemical blowing agent to provide the first part; and combining the first part with the second part comprising the hydride-substituted polyorganosiloxane to provide the curable composition.

Aspect 20: The method of aspect 19, wherein the first part and the second part are combined in a weight ratio of first part:second part of 6:1 to 25:1, or 9:1 to 20:1, or 9:1 to 15:1, or 9:1 to 12:1.

Aspect 21: A silicone foam sheet formed according to the method of any of aspects 18 to 20.

Aspect 22: The silicone foam sheet of aspect 21, wherein the silicone foam sheet has a thickness of 0.05 to 1.5 inches (1.27 to 38.1 millimeters), or 0.05 to 1 inch (1.27 to 25.4 millimeters), or 0.05 to 0.75 inches (1.27 to 19.05 millimeters), or 0.05 to 0.5 inches (1.27 to 12.7 millimeters), or 0.05 to 0.25 inches (1.27 to 6.35 millimeters), or 0.075 to 0.2 inches (1.905 to 5.08 millimeters), or 0.08 to 0.15 inches (2.032 to 3.81 millimeters); and the silicone foam sheet has a closed cell content of at least 50%; and a density of less than 240 kg/m³.

Aspect 23: The silicone foam sheet of aspect 22, wherein the silicone foam sheet has a compression force deflection of 0.4 to 10 pounds per square inch, or 1 to 5 pounds per square inch at 25% deflection and determined in accordance with ASTM D3574-17.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A curable composition for preparing a low density cast silicone foam comprising:
a first part comprising, based on the total weight of the first part:
40 to 70 weight percent of an alkenyl-terminated polyorganosiloxane;
0.1 to 10 weight percent of an alkenyl-substituted copolyorganosiloxane;
5 to 30 weight percent of an alkenyl-substituted MQ polyorganosiloxane;
a cure catalyst;
an inorganic filler; and
0.1 to 1.5 weight percent of a chemical blowing agent comprising
water,
a silanol-terminated polyorganosiloxane; and
optionally, an alcohol; and
a second part comprising a hydride-substituted polyorganosiloxane;
wherein the low density cast silicone foam has a density of less than 240 kg/m³; and
wherein the low density cast silicone foam has a closed cell content of at least 50%.

2. The curable composition of claim 1, wherein the first part comprises, based on the total weight of the first part:
50 to 60 weight percent of the alkenyl-terminated polyorganosiloxane;
0.5 to 5 weight percent of the alkenyl-substituted copolyorganosiloxane;
10 to 25 weight percent of the alkenyl-substituted MQ polyorganosiloxane;
the cure catalyst;
3 to 35 weight percent of the inorganic filler; and
the chemical blowing agent comprising water, alcohol, and
0.4 to less than 1 weight percent of the silanol-terminated polyorganosiloxane.

3. The curable composition of claim 1, wherein the first part and the second part are mixed together to provide the curable composition.

4. The curable composition of claim 1, wherein the alkenyl-terminated polyorganosiloxane comprises a vinyl-diterminated polydimethysiloxane.

5. The curable composition of claim 1, wherein the alkenyl-substituted copolyorganosiloxane comprises a vinyl-diterminated polydimethylsiloxane comprising vinyl pendent groups.

6. The curable composition of claim 1, wherein
the cure catalyst comprises platinum;
the inorganic filler comprises aluminum trihydrate; and
the chemical blowing agent comprises water, a C₁₋₁₂ monoalcohol, and the silanol-terminated polyorganosiloxane.

7. The curable composition of claim 6, wherein the chemical blowing agent comprises:
0.1 to 0.6 weight percent water,
0.1 to 0.9 weight percent of the C₁₋₁₂ monoalcohol; and
0.4 to less than 1 weight percent of the silanol-terminated polyorganosiloxane;
each based on the total weight of the first part of the curable composition.

8. The curable composition of claim 1, wherein the chemical blowing agent comprises:
greater than 0.5 weight percent water, and
0.08 to less than 1 weight percent of the silanol-terminated polyorganosiloxane.

9. The curable composition of claim 1, wherein the curable composition further comprises a monocarbinol-substituted polyorganosiloxane or a monofunctional-silanol.

10. The curable composition of claim 1, wherein the low density cast silicone foam has a thickness of less than 1.5 inches (38.1 millimeters).

11. The curable composition of claim 1, wherein the curable composition comprises a molar ratio of hydride groups to a sum of vinyl and hydroxyl groups of 1.1 to 2.5.

12. The curable composition of claim 1, wherein the curable composition is made by a method comprising:
combining the alkenyl-terminated polyorganosiloxane, the alkenyl-substituted copolyorganosiloxane, the alkenyl-substituted MQ polyorganosiloxane, the cure catalyst, the inorganic filler, and the chemical blowing agent to provide the first part; and
combining the first part with the second part comprising the hydride-substituted polyorganosiloxane to provide the curable composition;
optionally wherein the first part and the second part are combined a weight ratio of first part:second part of 6:1 to 25:1.

13. The curable composition of claim 1, wherein a fluorinated surfactant is present in an amount of less than 0.1 weight percent based on the total weight of the curable composition.

14. A cured silicone foam layer comprising a cured product of the curable composition of claim 1.

15. A method for forming a silicone foam sheet, the method comprising:
casting the curable composition of claim 1 onto a first release layer;
placing a second release layer on a side of the cast curable composition opposite the first release liner to form a multilayer structure;
passing the cast curable composition on the substrate through the nip of two rotating rollers to meter the amount of curable composition; and
curing the curable composition to form the silicone foam sheet.

16. The method of claim 15, further comprising:
combining the alkenyl-terminated polyorganosiloxane, the alkenyl-substituted copolyorganosiloxane, the alkenyl-substituted MQ polyorganosiloxane, the cure catalyst, the inorganic filler, and the chemical blowing agent to provide the first part; and
combining the first part with the second part comprising the hydride-substituted polyorganosiloxane to provide the curable composition.

17. The method of claim 16, wherein the first part and the second part are combined in a weight ratio of first part:second part of 6:1 to 25:1.

18. A silicone foam sheet formed according to the method of claim 15.

19. The silicone foam sheet of claim 18, wherein
the silicone foam sheet has a thickness of 0.05 to 1.5 inches (1.27 to 38.1 millimeters); and
the silicone foam sheet has a closed cell content of at least 50%; and
the silicone foam sheet has a density of less than 240 kg/m³.

20. The silicone foam sheet of claim 19, wherein the silicone foam sheet has a compression force deflection of 0.4 to 10 pounds per square inch at 25% deflection and determined in accordance with ASTM D1056-20.
